(19) United States
(12) Patent Application Publication
(10) Pub. No.: US 2005/0086022 A1
(43) Pub. Date: Apr. 21, 2005

(54) System and method for providing a standardized test framework

(75) Inventors: Lance E. Lindberg, Redmond, WA (US); Suryanarayana V. Putrevu, Sammamish, WA (US); Mohamed A. Ibrahim, Bellevue, WA (US); Liming Ren, Redmond, WA (US); Krishna Kumar Sunkammurali, Sammamish, WA (US); Ivan Santa Maria Filho, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/685,667

(22) Filed: Oct. 15, 2003

(51) Int. Cl. G06F 19/00

(52) U.S. Cl. 702/123

(57) ABSTRACT

A system for testing software may include a driver, dispatcher and one or more executors. One or group of test cases may be provided to the testing system. Each test case includes one or more actions and may be in the form of an XML document. Each action may be dependent on or independent of previous or following actions. In preparation for executing the test case one or more times, system initialization is performed. One or more iterations of the test case may be executed and housekeeping tasks may be performed in preparation for executing the next test case. Executing an iteration of a test case includes initialization in preparation for executing the iteration, performing the actions that test the software and validating the results (including comparing the actual result with an expected result and making entries to a log) and performing local cleanup (i.e., cleanup relevant to the iteration).

### FIELD OF THE INVENTION

The invention relates to software testing and in particular to providing a standardized test framework in which to test software.

### BACKGROUND OF THE INVENTION

Over the years, software systems have become more and more complex. Software, once typically developed by a single individual or a few individuals, now often requires a group of people with a variety of complementary skills working together towards a common goal. Large projects typically require the coordinated effort of many teams of developers. As the size and complexity of software increases, so too increases the task of software testing.

Software testing can be described as a process of running a program or set of programs in such a manner as to uncover any errors. One method of testing software is to develop test and run cases designed to uncover as many errors as possible. A test case describes an input, action, or event and an expected response, to determine if a feature of an application is working correctly. Test cases should be designed to “exercise” or “stress” the program by using and producing inputs and outputs. It would be helpful if there were a standardized, easily-understood way to develop and use test cases that addresses some of the old and new challenges in software testing.

### SUMMARY OF THE INVENTION

A system, method and computer-readable medium containing computer-executable instructions provides a framework for writing and executing test cases. The testing system may include a driver, dispatcher and one or more executors. One test case or a group of test cases may be provided to the testing system. Each test case includes one or more actions and may be in the form of an XML document. Each action may be dependent on or independent of previous or following actions. In preparation for executing the test case one or more times, system initialization is performed. One or more iterations of the test case may be executed and housekeeping tasks may be performed in preparation for executing the next test case. Executing an iteration of a test case includes initialization in preparation for executing the iteration, performing the actions that test the software and validating the results (including comparing the actual result with an expected result and making entries to a log) and performing local cleanup (i.e., cleanup relevant to the iteration).

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of a system for providing a test framework in accordance with one embodiment of the invention;

FIG. 3 is a flow diagram of a method for testing software in accordance with one embodiment of the invention;

FIG. 4 is a flow diagram of a method of preparing test cases and test groups;

FIG. 5 is an exemplary test case schematic in accordance with one embodiment of the invention;

FIG. 6 is an exemplary test case in accordance with one embodiment of the invention;

FIG. 7 is an exemplary test group schematic in accordance with one embodiment of the invention;

FIG. 8 is an exemplary test group in accordance with one embodiment of the invention; and

FIG. 9a-c is an exemplary test case schema in accordance with one embodiment of the invention.

### DETAILED DESCRIPTION OF ILLUSTRATIVE EMBODIMENTS

Overview

One test case or a group of test cases are input to a system including a driver, dispatcher and one or more executors. The driver may interface with a test case management system. The dispatcher drives actions specified in the test case through one or more executors. The one or more executors perform the action(s) specified in the test case or test group. A logger may log events such as trace statements, errors, warnings or other information of interest to a log file.

A test case may include an action or a series of actions to be performed and may identify an executor to perform the action. A test case may be provided as an XML file. A single test case or group of test cases may be provided for execution. A group of test cases may include one or more test cases and one or more groups of test cases.

When testing software, initialization in preparation for running the test case may be performed, the test case executed one or more times, and housekeeping tasks in preparation for running the next test case performed. Running an iteration of the test case comprises initialization in preparation for running the iteration of the test case, performing one iteration of the actions that test the software, and validating the results (e.g., comparing actual and expected results) and performing local cleanup (i.e., cleanup relevant to the iteration of the test case that has been run).

A method for preparing a test case includes identifying one or more actions required to test a feature. Each action within the test case may identify an executor to carry out the specified actions. Each test case may include one or more actions which are dependent on or independent of previous or following actions. A test case may also include a header that identifies files or databases to be acted on, and the like. The header may include meta-data pertaining to the test. For example, the header may include the owner of the test case, the title of the test case, a description of the test case, the priority for the test, the specific product feature or sub-feature that is to be tested and other data intended to describe the test. The test case may be presented as an XML document. After a test case has been developed, the test case may be copied and modified to create a new test case. Test cases may be combined into test groups. Test groups may include test cases, test groups or a mixture of test cases and test groups. Specified elements of a test file or test group may be tested sequentially or concurrently.

Exemplary Computing Environment

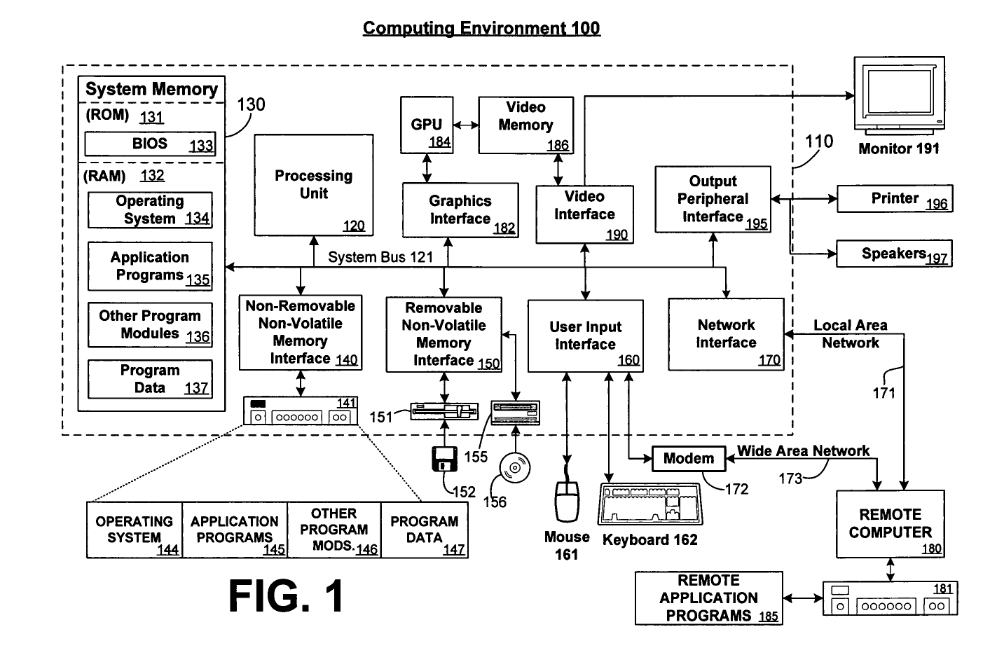

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1a illustrates operating system 134, application programs 135, other program modules 136, and program data 137.

The computer 110 may also include other removable/non-removable, volatile/nonvolatile computer storage media. By way of example only, FIG. 1a illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1a. The logical connections depicted in FIG. 1a include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1a illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

System and Method for Providing a Test Framework

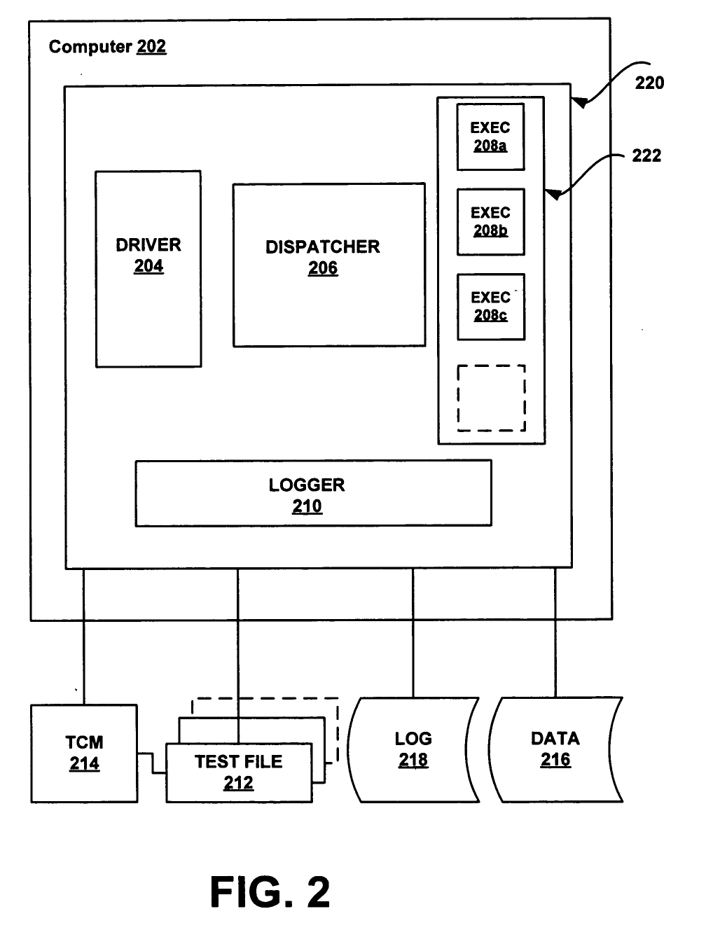

FIG. 2 illustrates an exemplary system for testing software in accordance with one embodiment of the invention. Referring now to FIG. 2, computer 202 represents a computer such as the one described with respect to FIG. 1, on which the invention may reside.

In one embodiment of the invention, software tester 220 is comprised of a driver 204, a dispatcher 206 and one or more executors 208a, 208b, 208c, etc. Driver 204 receives the input to the test framework. In one embodiment of the invention, driver 204 is a command line utility that is used to start up the software tester. For example, driver 204 may represent a command line utility to which is provided the path of a test case or a test group file. Driver 204 may also be provided with instructions concerning the execution of the test. Driver 204 may also provide a number of command line options to be used to control the execution of the provided input. Driver 204 may be a pluggable layer so that, for example, a user interface driver may be used instead of the command line driver described above. It will be understood that although a command line driver and a user interface driver have been described, the use of any kind of driver, is contemplated. Such a driver may be written to interface with any Test Case Management system (TCM), to read test cases from a database and exercise those tests. Some TCM systems, for example, may need to communicate with a driver that supports command line execution in which case driver 204 must support command line execution. Another TCM system may implement a callable interface (such as COM, NET, JAVA or the like), in which case driver 204 must be able to communicate with the called interface. Driver 204 may be written to support specific performance and stress testing requirements. For example, driver 204 may be developed to exercise all the test cases at one time, or to exercise the tests continuously for some period of time. Any of the above listed drivers or other suitable drivers are included within the scope of the invention. Driver 204 may interface with one or more test case management systems 214.

Dispatcher 206 reads the content of the input test file 212 and schedules an execution time for each action specified in the input test file 212. In one embodiment of the invention, execution times for the actions in the input test file 212 are scheduled sequentially, although any specified execution sequence is contemplated. In one embodiment, dispatcher 206 determines from the input test file 212 which executor 208a, 208b, etc. is capable of performing the commands in the action and directs the appropriate executor to execute the actions. For example, dispatcher 206 may read the name of the action from an input test case and from the name determine which executor in library 222 (described below) can perform that action. Dispatcher 206 may call the appropriate executor, pass the action to it and direct the executor to perform the action. Dispatcher 206 may then move on to the next action. In one embodiment of the invention, the default is to schedule action sequentially. There may be an option, specifiable in the test case XML or in the test group XML that indicates that the actions are to be performed in parallel instead of sequentially. In one embodiment of the invention certain actions can be specified to be performed in sequence while another set of actions are performed in parallel.

Tester 220 also includes one or more executors 208a, 208b, 208c, etc. Each executor may be a component or routine capable of executing a set of actions. Typically, an executor executes a set of related actions, although the invention is not so limited. For example an executor may be a component capable of compiling files of programs written in a new programming language. Similarly an executor may be a component capable of creating or updating database tables. In one embodiment of the invention, tester 220 includes a library of executors 222, the library comprising a number of executors 208a, 208b, etc.

Tester 220 may also include a logger 210. Logger 210 in one embodiment of the invention performs logging functions and records certain events that occur during execution. Log entries are typically used in debugging to determine where things went wrong. Logger 210 may record errors, warnings, trace statements and any other suitable events in a log 218. In one embodiment of the invention, the level of logging to be performed can be specified. For example, the level of logging may be specifiable via an option in the driver 204. In one embodiment of the invention if a level of logging is not selected, a default level of logging is performed, (e.g., warnings and errors are logged). In one embodiment of the invention, the log location is also specifiable, for example, log statements may be written to a file, a database, sent to an error control process, or to a window debugging function. In one embodiment of the invention, should log location not be specified a default log location (e.g., log statements written to a file) is selected.

In one embodiment of the invention, an exception based model is followed. In an exception based model, no flags are raised if no abnormal results are encountered. If an abnormal result is detected, whether in the driver, dispatcher or executor, an exception is logged, capturing relevant information associated with the exception. If the exception raised is a critical failure, the exception is bubbled back up to the driver, the driver declares a failure of the test case and the test case ends. When a non-critical exception is raised, information is logged and execution continues.

As an example of a noncritical exception, if in the testing of the compilation of a program in a new programming language, an unexpected compilation error is detected, the error may be logged or entered into a log file and the test case may be allowed to continue.

As an example of a critical exception, if in the testing of the compilation of a program in a new programming language, in first time initialize, the action specified is to compile a program XYZ located at path P, but program XYZ is not found at path P, a critical exception may be raised, information such as but not limited to “file XYZ not found at path P” may be logged in the log file and execution of the test case may terminate.

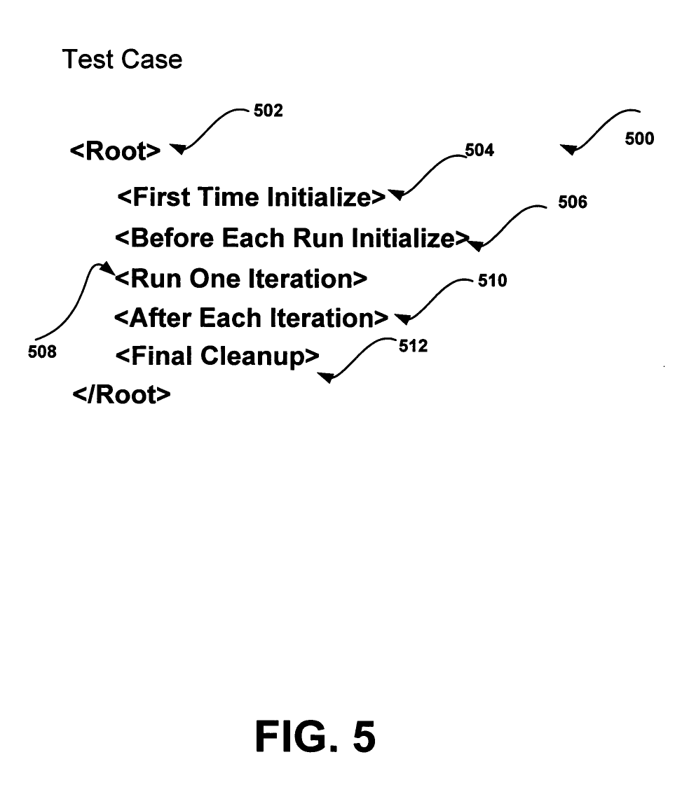

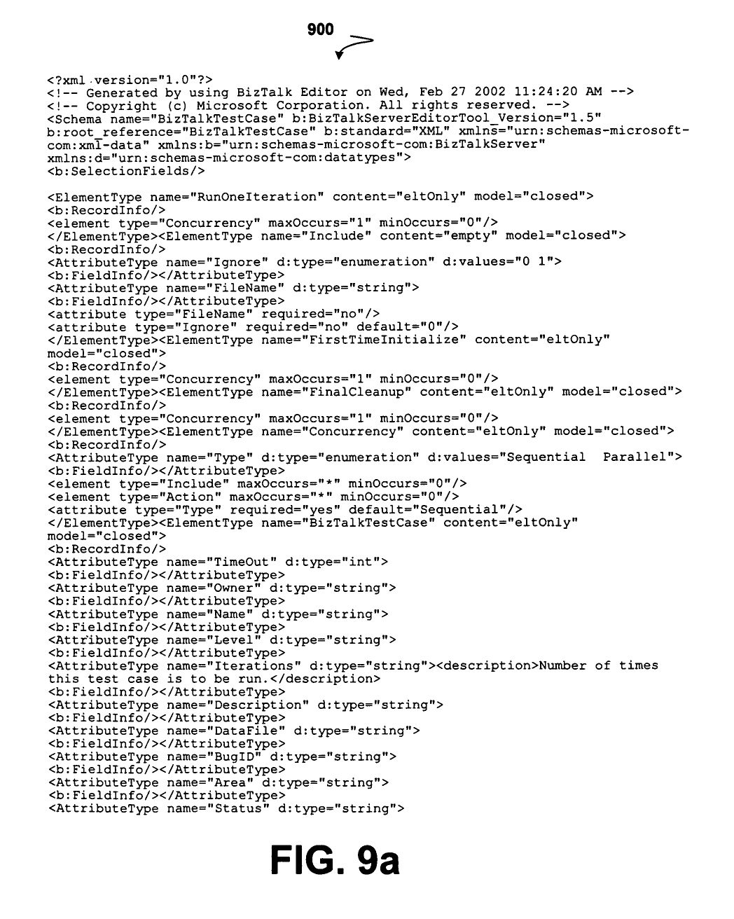

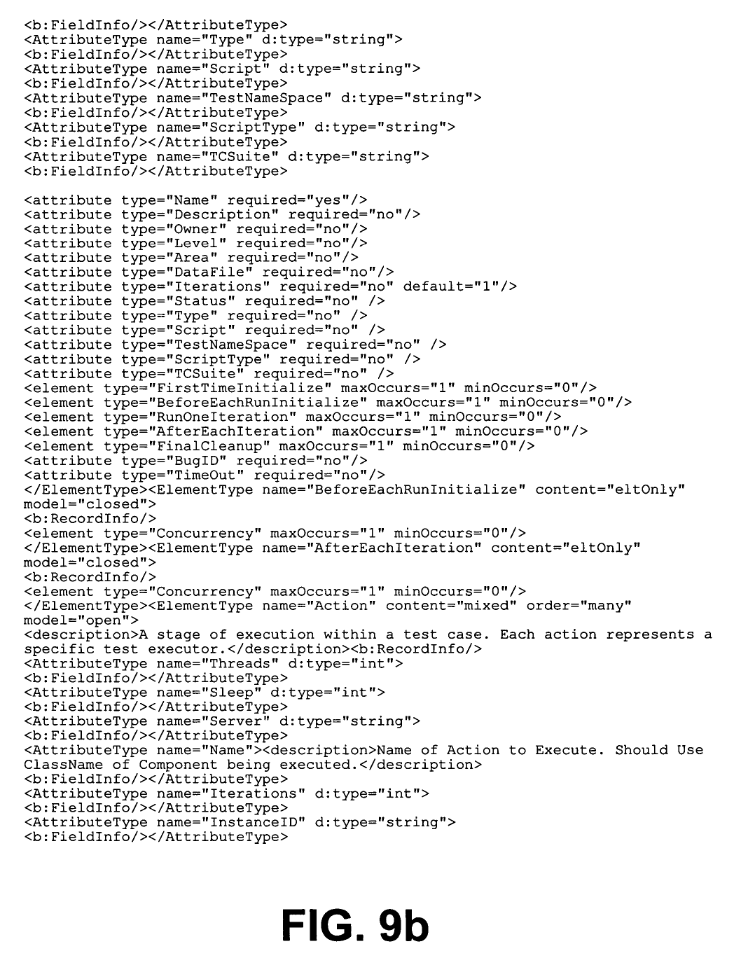

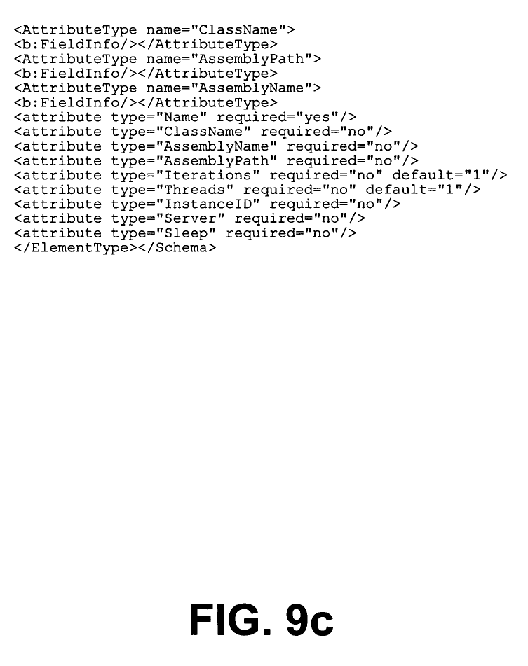

In FIG. 2, test file 212 represents input to tester 220. Test file 212 may be a single test case or may be a group of test cases. In one embodiment of the invention, the test file 212 is in the form of an XML document, although it will be understood that any suitable format for test file 212 is contemplated. An exemplary schema for such an XML document is illustrated in FIGS. 9a-c, XML schema 900. A single test case in accordance with schema 900 may include up to five elements, however any of the five elements may be missing in the test case. The schema 900 permits the content of each of these elements to be flexibly defined b meet the needs of the testing scenario. An exemplary XML test case 500 is depicted in FIG. 5. Test case 500 comprises a root element 502 having five children. In exemplary test case 500, child 504 is called “first time initialize”, child 506 is called “before each run initialize”, child 508 is called “run one iteration”, child 510 is called “after each iteration” and child 512 is called “final cleanup”. It will be apparent that although the children have been called by suitably descriptive names, any names chosen for the elements are contemplated as being within the scope of the invention.

Each of the elements 504, 506, 508, 510 and 512 may include one or more actions to be performed for the test case. “First time initialize” 504 represents a set of initialization actions that need to be performed in preparation for one or more executions of the test case. The middle 3 elements, “before each run initialize” 506, “run one iteration” 508, and “after each iteration” 510 represent the core of the test case and may be repeated or iterated a number of times. The fifth element, “final cleanup” 512 represents a set of actions that need to be done after the final iteration of the test case, to leave whatever system is being tested in condition for subsequent tests.

The middle 3 elements: “before each run initialize” 506, “run one iteration” 508, “after each iteration” 510 can be run zero or more times within a test case. “Before each run initialize” 506 may represent further initialization that needs to be done before an iteration of the test case is run. “Run one iteration” 508 represents one or more actions to be taken to execute one iteration of the test. “After each iteration” 510 represents actions to perform validation of results, (e.g., compare actual and expected results) and local cleanup after one iteration of the test. In one embodiment of the invention, “before each run initialize” 506, “run one iteration” 508, and “after each iteration” 510 can be performed repeatedly. Hence, for example, a particular execution of a test case could run “first time initialize” once, then the middle three elements several times, (i.e., N times) in a loop and “final cleanup” once. In one embodiment of the invention, the number of times, N, that the core is run is specified via a parameter submitted to the driver.

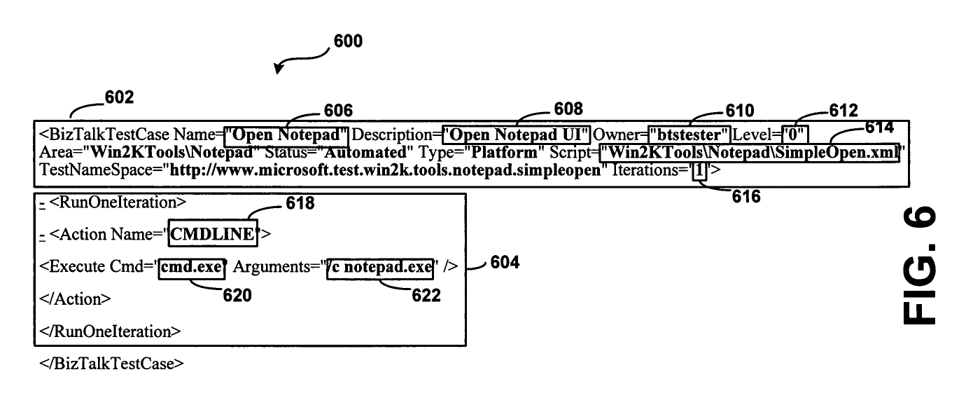

FIG. 6 illustrates an exemplary test case, 600. Test case 600 includes a header, 602, and one child, “Run one iteration” 604. Header 602 includes the title of the test case, “Open Notepad” 606, a description of the test case, “Open Notepad UI” 608, the owner of the testcase, “btstester” 610, the priority of the test case, “0” 612, the specific feature to be tested, “Win2KTool/Notepad” 614 and the number of iterations of the test to be performed, “1” 616.

Child 604 includes one action to be performed, “CMDLINE” 618. The “CMDLINE” action 618 includes information associated with the action, in this case, the name of the executable, “cmd.exe” 620 and the arguments that cmd.exe takes, “/c notepad.exe” 622.

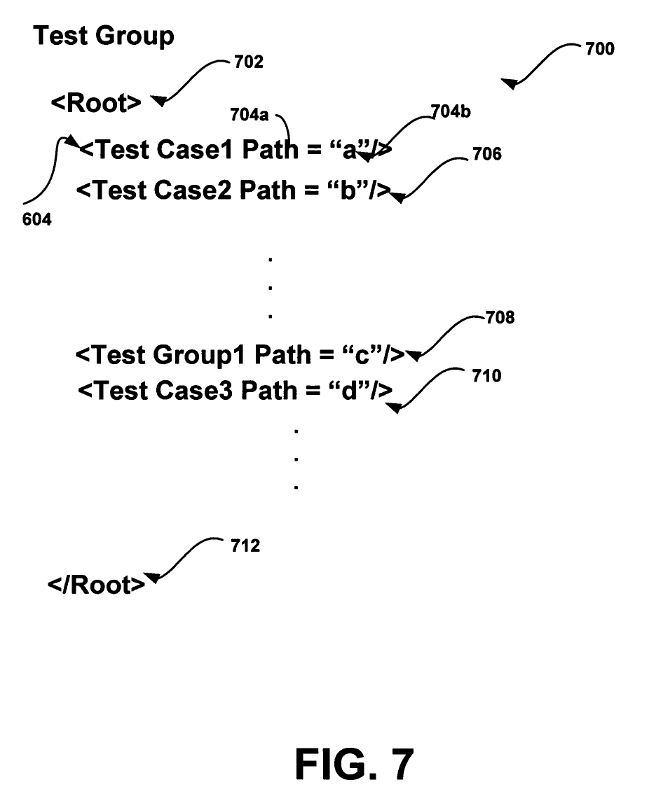

A group of test cases may be input to the tester. A test group may include individual test cases, test groups or a combination thereof. For example, XML file 700 of FIG. 7 includes root 702 which may include an optional group setup. The root 702 may be followed by zero or more elements 704, 706, 706, etc. Each element 704, 706, etc. may refer to a test case (e.g., elements 704, 706, and 710) or another test group (e.g., element 708). Each child element also may indicate a path to the folder location of an XML file. For example, element 704 indicates that Test Case 1 704a can be found at the path location “a” 704b. Similarly, element 708 indicates that Test Group 1 can be found at the path location “c”.

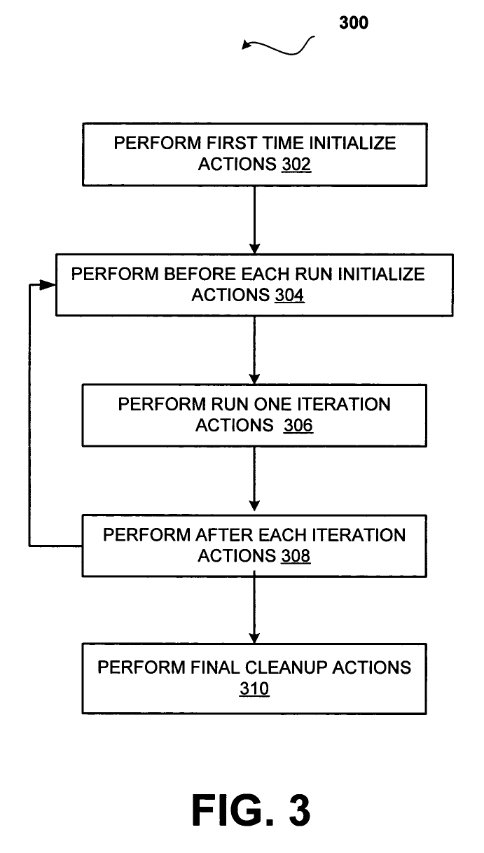

FIG. 3 is a flow diagram of an exemplary method 300 for testing software in accordance with one embodiment of the invention. A test file may be received. Selections for options and/or testing parameters as described above may be determined or defaults may be applied. The test file may be parsed to determine an action to be performed and the executor to be instantiated to perform the action. At step 302 the actions listed in “first time initialize” may be performed. These actions, as described above, are associated with global initialization of the system to be tested. At step 304, the actions listed in “before each run initialize” may be performed. As discussed above, these actions may be associated with the initialization for one iteration of the test case. At step 306, the actions listed in “run one iteration” are performed. As discussed above, these actions actually perform the test of the software. At step 308 the actions in “after each iteration” are performed. At discussed above the actions in “after each iteration” may be associated with verification of results of step 306 and/or cleanup between iterations. At this point, processing may loop back to step 304 if another iteration is to be performed or may go to step 310 if the final iteration has been executed. At step 310 the actions in “final cleanup” are performed.

Suppose, for example, a new programming language including a compiler and an engine for executing programs written in the new language is to be tested. In this situation, an appropriate test case may include a “first time initialize” action that would compile a specified program written in the new language, thus testing the compiler for the new programming language. The “first time initialize” element may place the compiled program in a location accessible to the execution engine so that the execution engine could execute the program in a later step. The middle three elements may test the execution engine by executing the compiled program a number of times. In each iteration, in “before each run initialize” the log may be cleared. In “run one iteration”, the compiled program may be executed once in each iteration. In “after each iteration”, validation of the results of the single execution may be performed for each iteration. Perhaps the compiled program would be executed three times, each time clearing the log in “before each run initialize” and validating the results of the execution in “after each iteration”.

As another example, suppose only the compiler is to be tested. In this situation, an environment to generate code may be set up in “first time initialize”. “Before each run initialize” may include an action to generate a particular program, “run one iteration” may include an action to compile the program and “after each iteration” may include an action to verify that the program was successfully compiled. It will be apparent that the test files can be geared to the particular focus of testing desired.

If a database application is to be tested in which 3 iterations are to be run, in “first time initialize”, tables may be created, in “before each run initialize” tables may be populated, in “run one iteration” operations on these tables may be performed and in “after each iteration”, results of this execution may be validated, (i.e., if in the test, four new records were to be added, the database would be checked to determine that the four new records are now in the database). In “after each iteration”, the tables may be cleared in preparation for the second iteration in which the tables would again be populated, the addition operation performed, the results validated and the tables cleared and so on. In “final cleanup” the tables may be discarded.

Suppose now Test Group 700 is to be executed. Upon execution of Test Group 700, Test Case 1 at the location specified by path “a” is executed, as described above with respect to FIG. 3 followed by Test Case 2 and so on. After Test Case 3 is executed, Test Group 1 is executed. Test Group 1 may include one or more test cases, one or more test groups or both, that is, test groups can nest test cases, test groups or a mixture of test cases and test groups. The nesting may continue for any number of nesting levels. Hence, upon execution of Test Group 700, Test Case 1 would be executed, Test Case 2 would be executed and so on, until Test Group I is executed. Suppose Test Group 1 includes Test Case 10 and Test Group 2. Suppose further that Test Group 2 includes Test Case 11. In this case, Test Case 10 is executed, Test Case 11 is executed, control returns to Test Group 6500 and Test Case 3 is executed and so on.

A test group may include individual test cases, test groups or a combination thereof. For example, XML file 700 of FIG. 7 includes root 702 which may include an optional group setup. The root 702 may be followed by zero or more elements 704, 706, 706, etc. Each element 704, 706, etc. may refer to a test case (e.g., elements 704, 706, and 710) or another test group (e.g., element 708). Each child element also may indicates a path to the folder location of an XML file. For example, element 704 indicates that Test Case 1 704a can be found at the path location “a” 704b. Similarly, element 708 indicates that Test Group 1 can be found at the path location “c”.

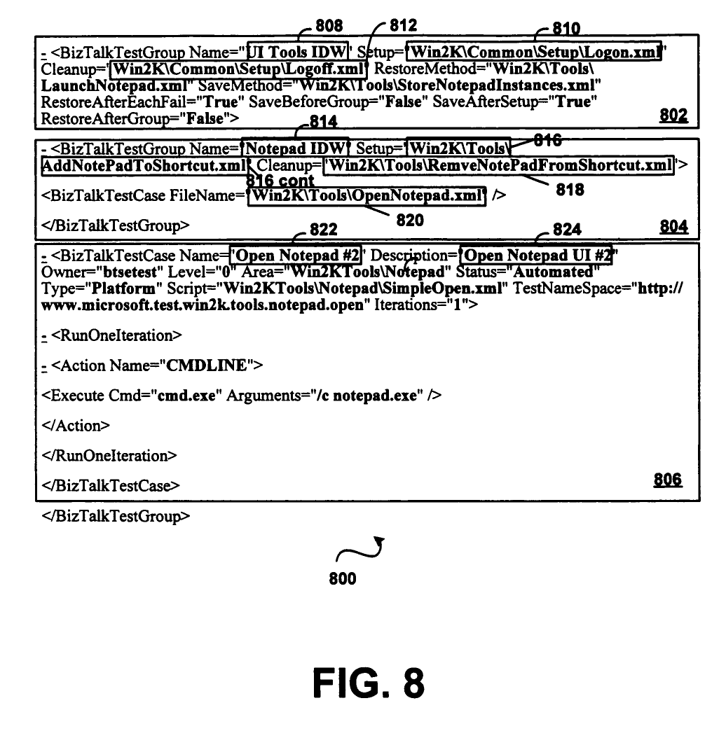

FIG. 8 illustrates an exemplary test group, 800. Test case 800 includes a header, 802, a test group “Notepad IDW” 804 and a test case “Open Notepad #2” 806. Header 802 includes the title of the test group “UI Tools IDW” 808, a group setup for test group 800 named “UI Tools IDW”: “Win2K\Common\Setup\Logon.xml” 810, a group cleanup for test group 800 named “UI Tools IDW”: “Win2K\Common\Setup\Logoff.xml” 812.

Test group “Notepad IDW” 804 includes a name “Notepad IDW” 814, a group setup 816 (“Win2K\Tools\AddNotePadToShrtcut.xml”) for the test group 804 and a group cleanup 818 for the test group 804. Test group “Notepad IDW” 804 also includes the test case file name on which the test is to be run: “OpenNotepad.xml” and its location or path: “Sin2K\Tools\OpenNotepad.xml” 820.

Test case “Open Notepad #2” 806 includes a name “Open Notepad #2” 822, a description “open Notepad UI #2” 824, and so on as described above for the test case of FIG. 6. Hence exemplary test group 800 illustrates a test group 800 that includes a nested group 804 and a test case 806 within it.

When developing Test Cases and Test Groups, Test Groups may be developed as a collection of Test Cases that test a particular feature and Test Groups may be developed as a collection of Test Groups that collectively test some or all of the features of a software system or complete application. Hence different Test Groups may have a different testing focus and may require special setup and cleanup actions. Each Test Group may therefore include group setup or group cleanup actions which in one embodiment of the invention are added after “<Root” in root element 702 and after </Root” in element 712. For example, in the exemplary test group 800 of FIG. 8, group setup for the group “UITools IDW” 802 is “Win2K\Common\Setup\Logon.xml” 810 and group cleanup for test group 802 is “Win2K\Common\Setup\Logoff.xml” 812. For test group “Notepad IDW” 804, the custom group setup is “Win2K\Tools\AddNotePadToShortcut.xml” 816 and the custom group cleanup is “Win2K\Tools\RemveNotePadFromShortcut.xml” 818.

Suppose for example, a set of stored procedures that populates a database is to be tested and a set of test cases to test these stored procedures is to be developed. In writing the XML for the first test case, in “before each run initialize”, perhaps an action to provide the sample data listed in the XML to the stored procedure would be listed. In “run one iteration” the action may be to execute the procedure using the sample data provided. In “after each iteration” an action to validate the outcome of the execution may be listed. The expected result may be listed in the “after each iteration” element so that the actual and expected results could be compared. In “final cleanup” an action to clear the database may be listed.

It will be apparent from the discussion above that using the test framework may simplify testing into a series of simple steps that can be used to test many diverse software systems. While the input and results may be different, the general template for the testing procedure is the same.

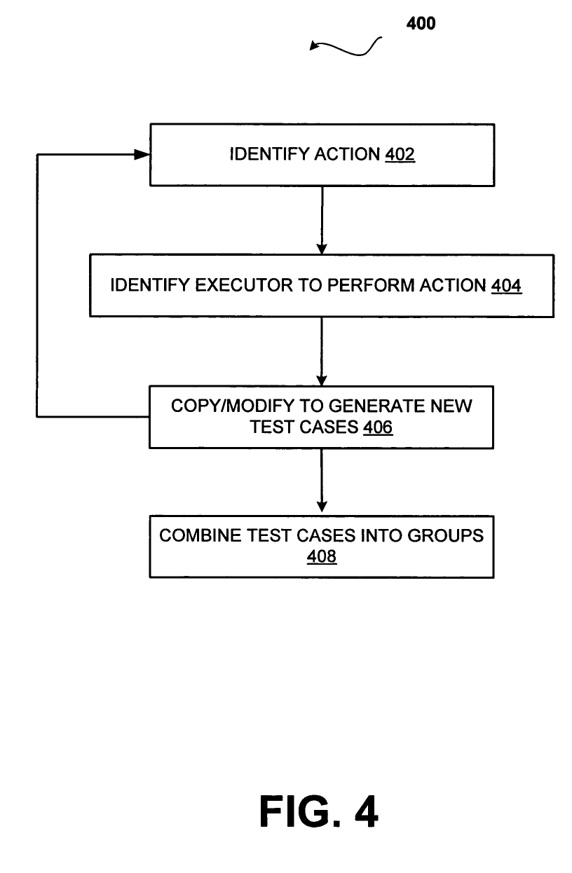

It is also apparent that the above described set of structures facilitates the development of test cases and test groups. FIG. 4 is a flow diagram of a method of preparing test cases and test groups for use in the testing framework described above. In step 402 an action to be performed and an executor capable of performing the action is identified (404). An action may be associated with initialization, execution, validation and/or cleanup. Steps 402 and 404 are repeated, generating a test case. Once a single test case has been generated, the test case may be copied and modified to generate a new test case 406. Test cases can be combined to create test groups (408) as described with respect to FIG. 6. The test cases and test groups can then be hierarchically combined for unified testing of larger segments of the software system.

Test cases and test groups can be generated independently, (for example, by different teams in a software development project, enabling a project team to develop tests independently of other teams). Suppose for example that a certain product has several subfeatures, each subfeature associated with its own development and testing team. Each team could develop a group of test cases to test its own subfeature. To test the whole product, all the test groups for all of the teams could be combined into a single test group that references all the teams' test groups. It will be apparent that such a test group may include several levels of test groups (i.e., test groups could be nested).

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Similarly it will be understood that although the test framework is described within the context of an automated way of testing software, the invention is not so limited and may be used wherever the scheduling of processes within a standardized format is useful, as for example in the context of business processes. Therefore, the present invention should not be limited to any single embodiment, but rather should be construed in breadth and scope in accordance with the appended claims.

1. A system for testing software comprising:
an executor for executing at least one action, the at least one action specified in an XML document,
a dispatcher for instantiating the executor to execute the at least one action; and
a driver for receiving information associated with the execution of the at least one action, and for sending instructions to the dispatcher.

2. The system of claim 1, further comprising a logger for logging information associated with the execution of the at least one action.

3. The system of claim 2, wherein the logger logs trace statements.

4. The system of claim 2, wherein the logger logs exceptions.

5. The system of claim 2, wherein the logger logs warnings.

6. The system of claim 2, wherein the logger logs errors.

7. The system of claim 1, wherein the driver receives input comprising a level of logging to be performed.

8. The system of claim 1, wherein the XML document comprises at least one action to be performed to test a software system and identifies an executor to execute the at least one action.

9. The system of claim 1, wherein the XML document specifies at least one action to be performed to initialize the software system.

10. The system of claim 1, wherein the XML document specifies at least one action to be performed to test the software system.

11. The system of claim 10, wherein the XML document specifies at least one expected result of performing the at least one action.

12. The system of claim 1, wherein the XML document specifies at least one action to restore the software to a testable state.

13. A method of testing software comprising:
determining at least one option associated with executing at least one action in a process, the action specifiable in an XML test case,
associating the at least one action with an executor capable of executing the at least one action; and
executing the action.

14. The method of claim 13 wherein the action comprises initializing a global testing environment.

15. The method of claim 13 wherein the action comprises initializing a testing environment for a single iteration of the test case.

16. The method of claim 13 wherein the action comprises a test operation.

17. The method of claim 13 wherein the action comprises validating the result of the test operation.

18. The method of claim 13 wherein the action comprises restoring a testing environment to a testable state.

19. A method of generating a test case comprising identifying at least one action to be taken to test software and identifying an executor capable of executing the at least one action.

20. The method of claim 19, wherein the test case is a first test case and the first test case is copied and modified to generate a second testcase.

21. The method of claim 20 wherein a test group is generated by combining the first and second test cases into a test group.

22. The method of claim 21 wherein a second test group is generated by combining the test group with a third test case to generating a second test group.

23. A computer-readable medium including computer-executable instructions for:
determining at least one option associated with executing at least one action in a process, the action specifiable in an XML test case,
associating the at least one action with an executor capable of executing the at least one action; and
executing the action.
